(19) United States
(12) Patent Application Publication
(10) Pub. No.: US 2018/0189870 A1
(43) Pub. Date: Jul. 5, 2018

(54) MULTI-DATABASE SYSTEM FOR STORING DATA FROM MULTIPLE DATA SOURCES

(71) Applicant: Early Warning Services, LLC, Scottsdale, AZ (US)

(72) Inventors: Laura E. Weinflash, Scottsdale, AZ (US); Larry W. Spooner, Green Valley, AZ (US)

(21) Appl. No.: 15/828,075

(22) Filed: Nov. 30, 2017

Related U.S. Application Data
(63) Continuation-in-part of application No. 13/947,271, filed on Jul. 22, 2013.
Application No. 13/947,271 is a continuation of application No. 12/126,474, filed on May 23, 2008, now Pat. No. 8,510,224.
Application No. 12/126,474 is a continuation of application No. 10/144,740, filed on May 14, 2002, now Pat. No. 7,383,227.

(51) Int. Cl. G06Q 40/02; G06Q 20/04; G06Q 40/00

(52) U.S. Cl. CPC G06Q 40/02; G06Q 40/12; G06Q 20/042

(57) ABSTRACT

A plurality of banks of first deposit provide checking account activity data for both transit items (checks received for deposit that need to be cleared) and incoming returns (bounced checks) to a statistical model which determines from the data the likelihood that a check from a specific checking account will be returned. This data is used to populate a database of checking accounts to be used for making check risk decisions, such as check hold policy decisions, check acceptance decisions, and open to buy decisions.

### BACKGROUND OF THE INVENTION

Many database systems receive data from multiple data sources. The multiple data sources often provide data relating to different entities and persons, and provide the data in different formats. At the same time, an entity that needs to access such data after it is stored in a database system may only need certain portions of such data (e.g., data pertaining to a specified category of entities). As a result, database systems that receive data from multiple data sources often encounter technical difficulties in organizing the data for being stored (since it may be provided in different formats) and in providing efficient access to the data when only certain categories of the data are needed (since the database system would need to search through its entire contents to find the data being requested).

These problems are particularly critical when data from a database is needed to be quickly stored and thereafter immediately available for retrieval. For example, an entity that wants to access data to make rapid and significant decisions based on that data, will want the data to be as current as possible (new data arriving needs to be properly formatted and stored quickly) and to be as quickly retrieved as possible.

Thus there has arisen the need for providing databases that can receive data from multiple, different data sources, organize the data for quick storage in the database, and make the needed data quickly available for retrieval.

### BRIEF SUMMARY OF THE INVENTION

Aspects of the present invention provide a multi-database system structure that facilitates both the receipt and storing of data from multiple different data sources and the retrieval of such data for various purposes, such as authentication/verification.

One preferred embodiment of the present invention provides a computer-implemented process which populates a database with checking account and statistical data regarding the likelihood that a check from a specific checking account will be returned.

Embodiments of the invention include a multi-database structure (including, e.g., a dual database system) that provide significant advantages over prior database systems used in check verification systems. The dual database system, with one database having highly accurate and current account status and item level data from accounts maintained at institutions that belong to the member service, and a second database that includes reliable check risk data obtained from account activity (transit item files and return files) from virtually all accounts other than those represented in the first database, provides one system where virtually any check can be verified with speed, accuracy at one system managed by the member service that operates the dual database system. The system returns reliable and accurate data concerning the accounts at member institutions, and if the check verification inquiry is not directed towards an account at a member institution, quickly and efficiently provides a response to the check verification inquiry for accounts at non-member institutions. The database system advantageously removes member account data from the second database so that second database is not populated with data pertaining to member institutions, and thus removes overlapping data that would otherwise slow access to data in the second database. This provides a system that efficiently manages the storing and retrieval of relevant data by having only data pertaining to member institutions in the first database and only data pertaining to non-member institutions in the second database.

Embodiments thus not only provide more complete and accurate risk-related data at a check verification system used by an institution to which a check has been presented, but also eliminates the need for accessing multiple databases from multiple sources (while at the same time representing a more comprehensive source of risk data for evaluating virtually any presented check).

In some embodiments, efficiencies are further obtained by obtaining, from member institutions, account activity for accounts at nonmember institutions. For example, any given member institution likely receives activity data for accounts at non-member institutions, based on checks deposited into accounts at the member institution. When collected from all the member institutions, it is likely that most if not all accounts at nonmember institutions ultimately have activity data passed through a member institutions. Since the data comes from different member institutions, activity data relating to accounts at other member institutions (i.e., member institutions other than the specific institution providing the activity data) is removed in the manner described earlier. It should be understood that when the dual database system is managed by the member service, the member service is in the best position to determine which data needs to be dropped or stripped so that the second database has only data pertaining to accounts at non-member institutions.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIGS. 1-3 are schematic block diagrams of conventional check risk decision and check clearing processes;

FIG. 4-5 are schematic block diagrams of check risk decision and check clearing processes in accordance with the present invention;

FIG. 6 is a flowchart of the process shown in FIG. 5;

FIG. 7 shows a block diagram of one suitable scoring model process for use in one preferred embodiment of the present invention; and

FIGS. 8-12 show how to populate and maintain the non-participant database.

FIG. 13 illustrates a system used to receive, reformat, filter and score transit items and incoming returns.

FIG. 14 illustrates details of the file types seen FIG. 13, into which transit item and incoming return data is reformatted.

FIGS. 15 and 16 show how to populate and maintain the non-participant database in accordance with alternative embodiments.

FIG. 17 is a block diagram of a specially programmed computer system upon which various systems and processes described in conjunction with FIGS. 4-14 may be implemented.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

Embodiments of the present invention provide a multi-database system that receives data from multiple, different data sources, organizes/reformats the data for quick storage in the database, and makes needed data quickly available for retrieval.

In one specific embodiment, the multi-database system receives data from a plurality of different institutions, such as financial institutions. The multi-database system is used by members of a service that access the data to make immediate decisions on circumstances where quick and accurate to the data is needed, such as to verify/authenticate a transaction. For example, the members of the service may be banks that need to authenticate/verify an account that is being used to conduct a transaction, such as a check account transaction.

In this specific embodiment, the multi-database system is operated by the member service, in which the members are entities that receive “checks” for deposit or as payment. The system is used by an entity receiving the check to access data pertaining to the account against which the check is drawn.

The overall environment in which the present invention is used is described in co-pending U.S. application Ser. No. 13/947,271, filed Jul. 22, 2013, for “DATABASE FOR CHECK RISK DECISIONS POPULATED WITH CHECK ACTIVITY DATA FROM BANKS OF FIRST DEPOSIT,” which application is hereby incorporated by reference for all purposes herein.

As described in U.S. application Ser. No. 13/947,271, check clearing is the process of reconciling payments among parties associated with a check-based financial transaction. Most checks are processed in the following manner; The entity to whom the check is made out (the payee) deposits the check in his or her bank (the bank of first deposit or the depository bank). If the check writer's (the payor) account is in the same bank, the check is “on-us” and it is processed at the bank. Otherwise, the physical check travels, often via a financial intermediary, to the payer's institution or bank (the paying financial institution or bank), and finally to the payor, who receives the canceled checks and/or an account statement of the canceled checks on a periodic basis, typically monthly. The checks that must travel (interbank transit checks) may be handled by multiple institutions. If the payor has insufficient funds in his or her account to clear the check, or if the paying financial institution does not honor the check for other reasons, the check travels back to the bank of first deposit and possibly back to the payee. The payee suffers a payment loss on checks that do not clear.

The figures in the present specification illustrate both the prior art and the present invention, and depict “paper check processing.” However, there are other financial instruments, such as debit cards, electronic checks (echecks), and Automated Clearing House (ACH) debit system transactions, which are ultimately tied into the checking account of a payor institution, and thus are functionally equivalent to paper checks. For simplicity, both the prior art descriptions and the present invention collectively refer to all of these types of financial instruments as “checks.”

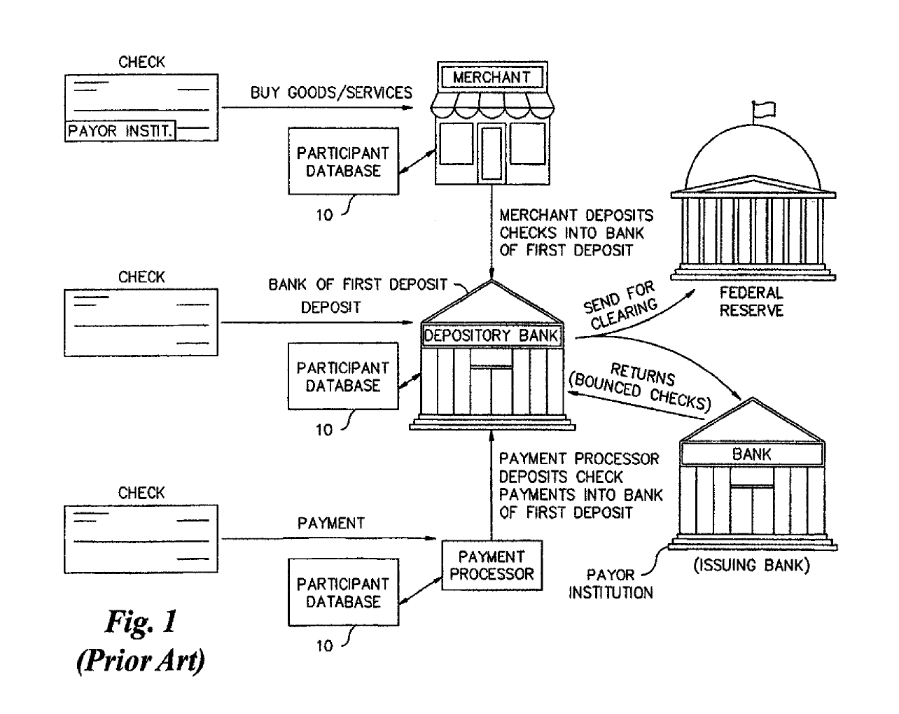

FIG. 1 shows examples of three conventional channels of check activity for use of the customer's checks. In one channel, a customer presents a check to a merchant to buy a product or service. The merchant, in turn, deposits the check into a “bank of first deposit,” also known as the “depository bank.” In a second channel, a customer deposits a check directly into a bank of first deposit (the check may or may not be drawn on the bank of first deposit). In a third channel, the customer makes a payment to a payment processor. Like the merchant, the payment processor, in turn, deposits the check into a bank of first deposit. The bank of first deposit sends all checks (other than its own) to be cleared to the Federal Reserve and/or directly to the payor institution (e.g., payor bank).

FIG. 1 of U.S. Pat. No. 5,175,682 (Higashiyama et al.) and the corresponding description on column 1 of this patent provides a general overview of one conventional check clearing process for the merchant channel discussed above. In FIG. 1, the merchant bank 103 is the bank of first deposit, and the issuing bank 106 is the payor institution that issued the customer a checking account on which check 101 is drawn.

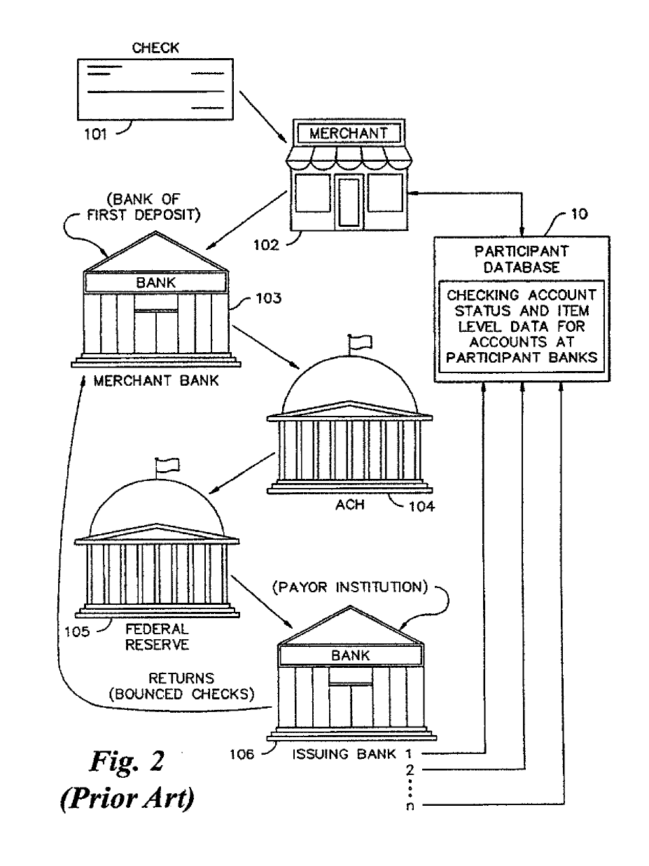

A “return item” is a check that is returned unpaid by the paying (payor) institution to the bank of first deposit, usually for insufficient funds. These bounced checks are reported back to the bank of first deposit in a “returns file.” FIG. 2 of the present specification illustrates FIG. 1 of U.S. Pat. No. 5,175,682 appended to show returns being sent by the issuing bank 106 to the merchant bank 103. A similar flow of returns occur in FIG. 1 of the present specification. (Return items that flow out of the payor institution are referred to as “outgoing returns,” whereas return items that are received by a bank of first deposit are referred to as “incoming returns.”)

FIGS. 1 and 2 of the present specification also shows a prior art check risk decision process associated with a risk assessment service. A merchant, bank of first deposit, or payment processor may subscribe to a service that assesses the risk that a check will be returned on an account based on checking account status and item level data provided by the payor institution. This may be done immediately or in an overnight batch process.

The risk assessment service maintains a single “participant database” 10 (shown in separate blocks in FIG. 1 for each channel for ease of illustration) which is populated on a daily basis with the checking account status and item level data of accounts at certain payor institutions (i.e., the participants) that belong to a member service or member network. FIG. 2 also shows the role of the participant database 10.

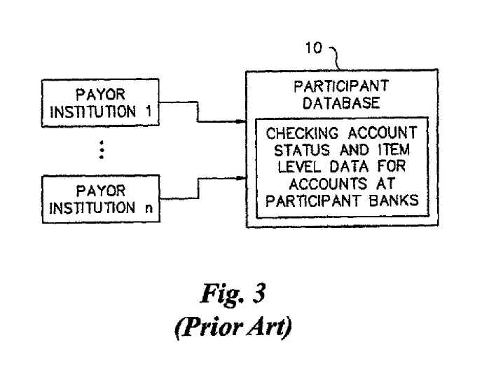

FIG. 3 shows that the prior art participant database 10 is populated by a daily flow of checking account status and item level data from each of the participant payor institutions. Some examples of a checking account status data are provided below (meaning of the status is noted in parenthesis where needed for a full understanding):
PRESENT (balance is greater than zero)
NEW ACCOUNT
CLOSED
NSF STATUS (balance is less than zero)

Some examples of item level data are provided below:
STOP PAYMENTS
EARLY OUTGOING RETURN NOTICES

Depending upon the information in the participant database 10, along with other pieces of key information such as the depositor's current balance, number of returns, past experience, a depository bank or institution may place an extended hold on the deposit if there is reason to doubt collectability. In the payment world, a payment processor may use this information to make a decision regarding whether or not to open the line of credit or “open to buy” until the check clears. A merchant may also use the information to decline to accept the check. The participant database is a highly reliable source of data because it is populated with actual checking account status and item level data received directly from the payor institutions. Accordingly, merchants, banks of first deposit, and payment processors can make accurate check risk decisions (e.g., check acceptance decisions and check hold decisions). Early Warning Systems, LLC (EWS), Scottsdale, Ariz. (formerly known as Primary Payment Systems, Inc.) provides advance notice of potential check returns to inquiring customers using the participant database described herein.

One significant deficiency with the conventional schemes described above is that not all payor institutions belong to (i.e., are members of) the risk assessment service that maintains the participant database, and thus not all checking accounts have checking account status and item level data present in the participant database. If a check is presented from an account of a non-participating payor institution, then the merchant, bank of first deposit, or payment processor must rely on other sources of data to make a check risk decision, such as calling the payor institution directly, using other check verification services that obtain data from other sources, or reviewing past check history records for the customer that is presenting the check or the account that the check is drawn on. Entities that accept checks, and which already use services such as those provided by EWS, would like to rely upon a better and more accurate source of data when determining the likelihood that a check from a specific checking account that is not in the participant database will be returned so that better and more accurate check risk decisions can be made.

Check verification services currently used by merchants, banks and the like in making check acceptance decisions have many deficiencies. Some of the deficiencies are discussed below:

1. Services that use “negative file” databases which contain checking account numbers that are known to be closed or delinquent are typically based on return experiences from selected merchants, and thus are limited in scope and may become stale or outdated.

2. Retail merchants, financial institutions, check cashing services, check printing companies, collection agencies, and government agencies routinely report incoming returns (e.g., bounced checks), closed accounts, new check orders, and the like to private services, who, in turn, use this information in developing proprietary databases such as negative files for check verification. However, the vast majority of checking account activity data consists of checks that clear with no problems. The proprietary databases either do not capture such activity data, or they capture it from sources that are limited in scope (e.g., selected merchants as described in the previous paragraph). Incoming return data has much better meaning when combined with transit items which include therein checks that will ultimately clear with no problem. Consider, for example, a checking account holder who writes 100 checks in one year, averaging $40.00, but then accidentally bounces one $15.00 check during the course of the year. Many existing check verification services will flag the account as a problem account due to the bounced check, when, in fact, the likelihood of a check clearing on the account is extremely high.

3. Some check verification services use predictive models based on multiple variables to determine the level of risk associated with a particular check transaction. However, the predictive models may not take into account actual check activity behavior of the check presenting customer, Thus, a customer who has a stellar check activity record might fit a profile of a bad check writer and be negatively treated as a result of the profile which may not even factor in actual check activity. U.S. Pat. No. 5,679,938 (Templeton et al.) describes the use of a typical predictive modeling system.

4. Conventional check verification databases that are built from retailer (merchant) check activity data inherently miss a large percentage of checking accounts that are rarely, if ever, used for consumer-type purchases. Furthermore, a large percentage of retailers do not subscribe to, or report check activity to, a check acceptance service, and thus the databases do not contain a complete picture of the check writing activity of the checking accounts that even make it into the databases. Positive files (positive databases), negative files (negative databases) and velocity/risk databases, which are typically created by check acceptance services used by retailers, suffer from these deficiencies. Even the largest commercially available services today have no checking account activity data on about half or more of active checking accounts.

Thus prior check verification systems may have various databases that provide information that comes from various sources. An entity (such as a bank of deposit, a merchant, or a payment processor) that receives a check may have access to all of the commonly available databases from multiple sources (positive databases, negative databases and velocity/risk databases), but still be unable to assess risk based on account activity at a substantial number of active accounts. Further, the data from such multiple sources may not only be incomplete, but the available data is overlapping since it comes from multiple sources, which may slow the check verification process.

Despite the multitude of existing check verification and acceptance services, there is still an unmet need for a service that can be used to make statistically significant check risk decisions based at least in part on actual checking account activity data for a greater percentage of active checking accounts, and which can be used with confidence by merchants, banks and payment processors alike and at the same time permit the check verification systems to operate with greater accuracy and speed. The present invention fulfills such a need.

### 1. Overview of Present Invention

Banks of First Deposit receive incoming returns on a daily basis for checks that they previously submitted for clearing. The checking account data from the incoming returns are received in “incoming returns files.” (No “early notice returns” are included in these files.) Each business day, Banks of First Deposit also receive a large volume of checks that they accept for deposit from merchants, consumers, small businesses, corporations, and payment processors. These checks are sent for clearing, typically on a daily basis. (“On us” checks are cleared within the bank.) The checks that the Banks of First Deposit receive and which must be cleared are “transit items,” as discussed above. Checking account data from the daily transit items are consolidated into “transit item files.” The present invention taps the rich source of information contained in the incoming returns files and the transit item files, and then uses the information to create a “non-participant database” that can work alongside of the existing participant database, or as a stand-alone database. In this manner, merchants, banks, and payment processors can further reduce payment losses from bad checks.

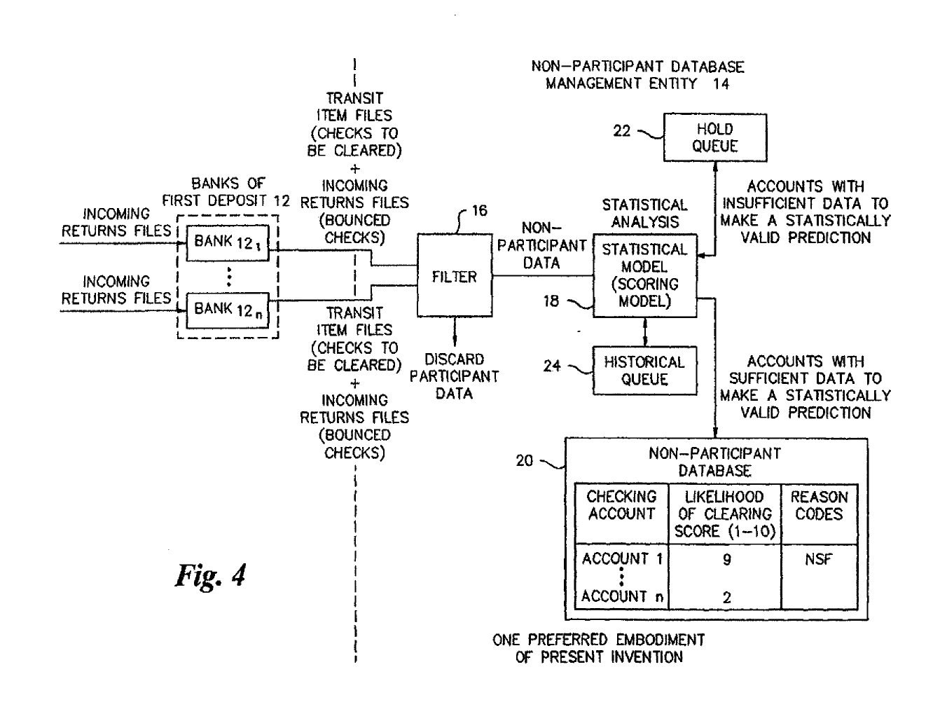

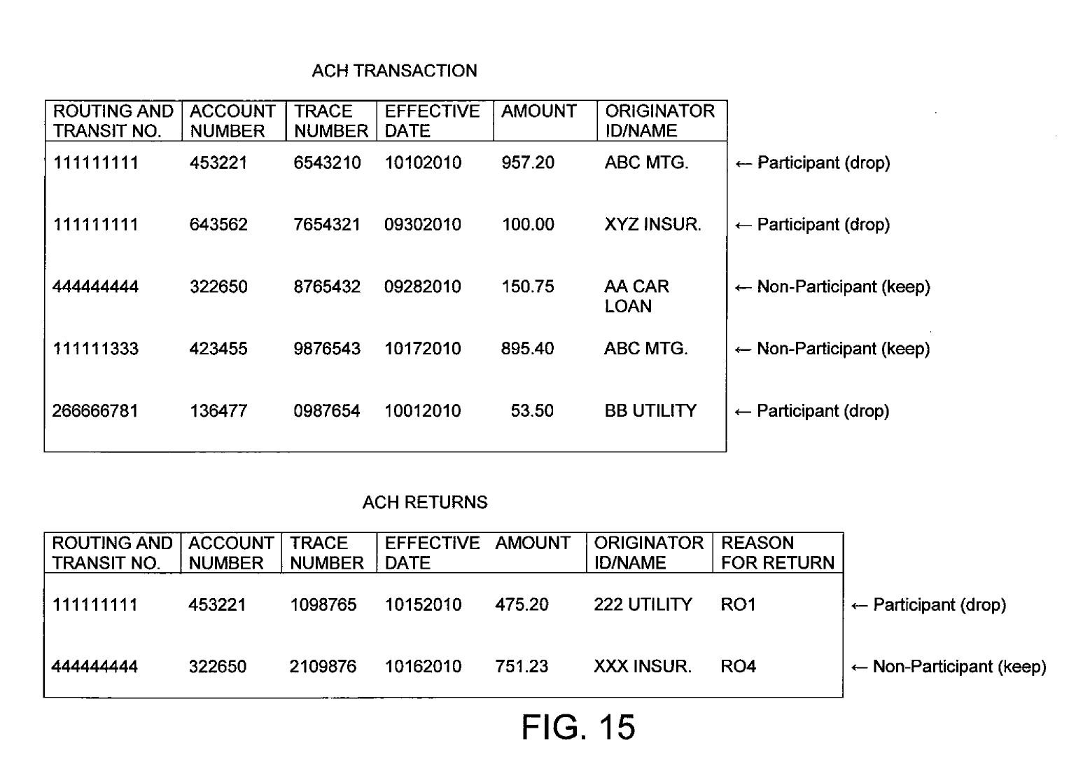

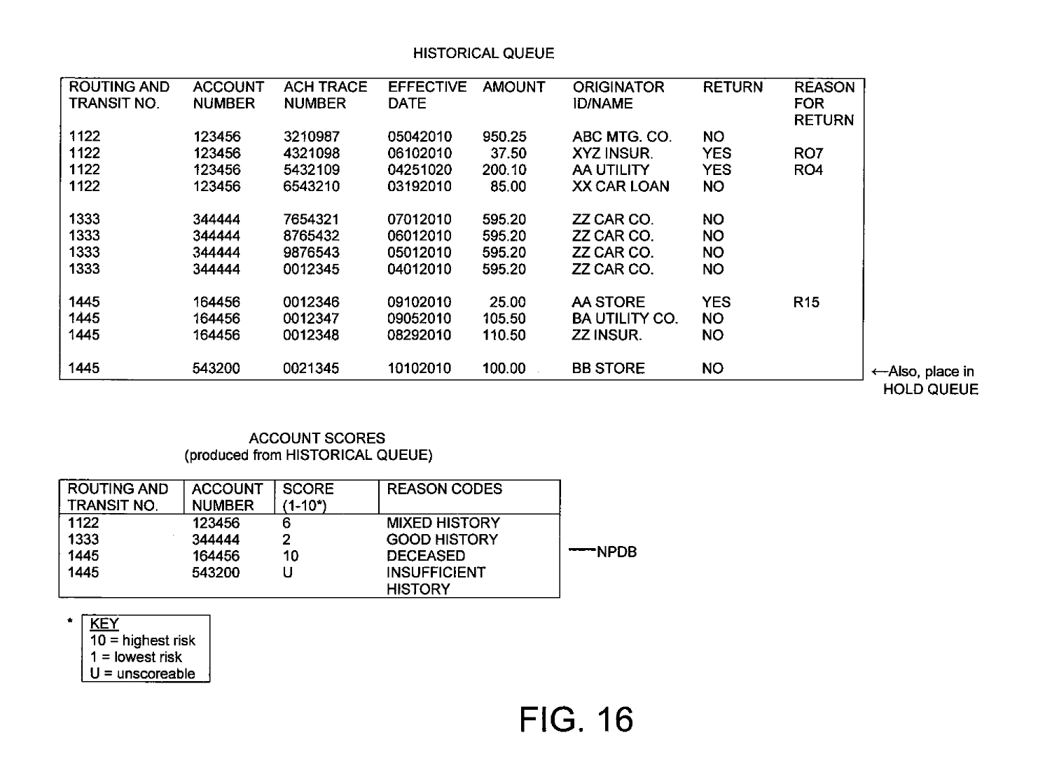

In the following description relating to FIGS. 4-12, the data being processed is described largely in the context of checking account activity data (e.g., item transit files and incoming return file) resulting from the traditional processing of paper checks. However, as mentioned earlier, the invention is not limited to such activity, and much of that description will relate equally to checking account activity data resulting from ACH transactions (e.g., ACH transaction files and ACH return files), as will be apparent from the embodiments described later in conjunction with FIGS. 15 and 16.

FIG. 4 shows how financial institution data from banks of first deposit 12 are to be used. The banks transmit their transit item files (including checks to be cleared) and incoming returns files (including bounced checks) on a daily basis to a non-participant database management entity 14. This entity removes participant data via filter 16 since that data is already collected and accounted for in the conventional participant database scheme.

Transit item files contain the MICR line data including the routing and transit number, account number, tran code or its equivalent if applicable, serial number (check number), dollar amount and date. Incoming returns contain the routing and transit number, account number, tran code or its equivalent if applicable, serial number (check number), date and reason(s) for return.

The non-participant data is applied to a statistical model 18 (also, referred to as a “scoring model”) which uses statistical analysis to determine the likelihood that a check from a specific non-participant checking account will return (i.e., not clear). The results of the statistical model are used to populate a non-participant database 20. If there is insufficient data about a checking account to make a valid determination, then the data is sent to a hold queue 22. As additional data arrives for a checking account that is in the hold queue 22, the hold data is reapplied to the statistical model 18. The additional data is also used in association with a historical queue 24 to make fresh determinations of the likelihood of clearing for checking accounts that are in the non-participant database 20. That is, the statistical model 18 is periodically rerun using fresh data, and the non-participant database 20 is updated with new scores. Over time, many of the accounts in the hold queue 22 should migrate to the nonparticipant database 20. Eventually, the non-participant database 20 will include likelihood data for most of the non-participant checking accounts.

In the preferred embodiment of the present invention, any new checking account numbers that pass through the filter 16 and which are not already in the non-participant database 20 are added to the non-participant database 20, even if no likelihood data is available due to the inability to make a valid determination. These checking account numbers are flagged and stored in the hold queue 22. These accounts are not scored. In an alternative embodiment, unscoreable checking account numbers are not entered into the non-participant database 20.

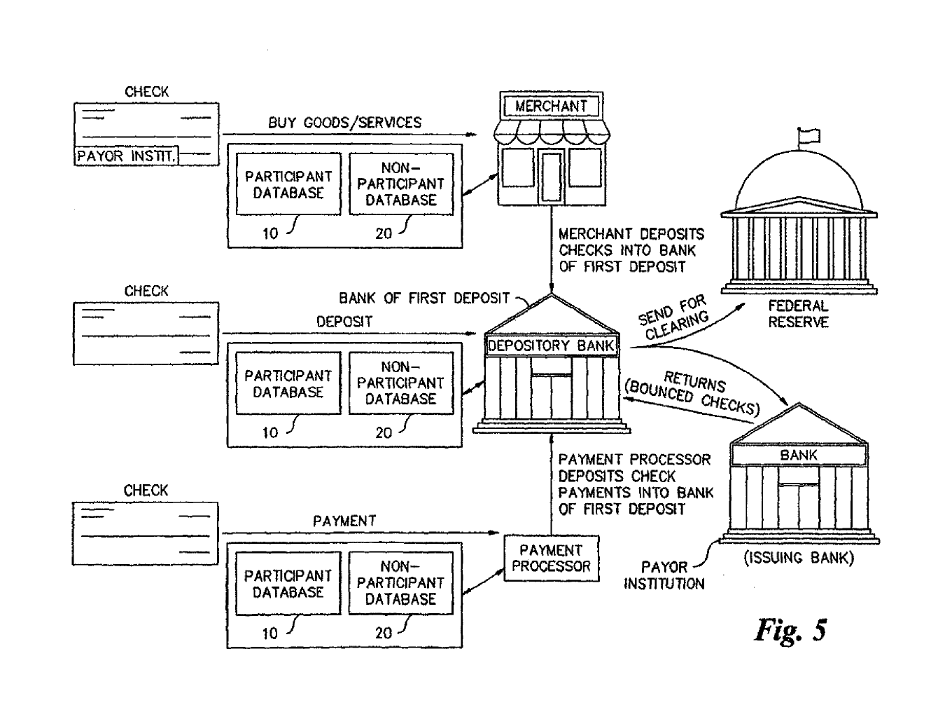

FIG. 5 is similar to FIG. 2, except that FIG. 5 shows the non-participant database 20 working alongside the participant database 10. A merchant (or alternatively, a merchant processor or check acceptance company), depository bank (or alternatively, a depository bank processor), or payment processor evaluates the risk of the check by using the participant data via the participant database process described in FIG. 1. However, checks from a non-participant checking account are run against the accounts in the non-participant database 20. If the checking account is in the non-participant database and the inquirer is satisfied with the level of risk associated with the account, as indicated by a score, then the inquirer will accept the check and/or apply any appropriate hold policies to the check. Alternatively, the inquirer may also combine the score from the non-participant database 20 with other information about the check presenter in making check acceptance and/or check hold decisions. If the checking account of the presented check does not appear in either database 10 or 20, or if the checking account of the presented check appears in the database 20 with an unscoreable indicator, then the inquirer will use other information to evaluate the risk of the check.

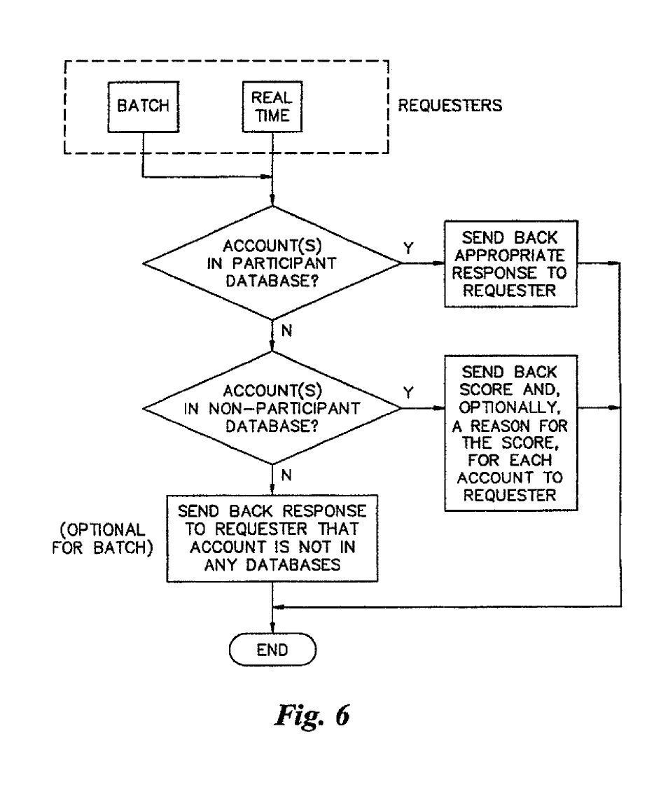

FIG. 6 is a flowchart of the process shown in FIG. 5. The process begins when an entity makes an inquiry regarding one or more checking account numbers. The inquiry may be part of a batch process or a real time process. The inquiry generates a hit report with scores for each hit, and, in some instances, up to five reason codes for the score. Reason code(s) are included only for certain types of inquiries from certain entities.

A real time inquiry can be made by swiping a check with a MICR reading device. There are numerous MICR capture devices, including, but not limited to, dial-up MICR readers which directly access a database (e-g., EWS's database), and integrated online services which connect through merchants or teller windows. In one preferred embodiment, the check reader dials into a database containing the databases 10 and 20, and receives a response therefrom. Responses from the database 20 include the score data, and, optionally, reason codes(s) if any exist.

If an account is not in the database, the requester is informed of this fact. In one alternative embodiment, this step occurs only for real time inquiries and is not performed for batch inquiries. The remaining steps in the process shown in FIG. 6 are self-explanatory.

One important feature of the present invention is that the non-participant database 20 is built from all transit item files and incoming returns files supplied by banks of first deposit 12. In one preferred embodiment of the present invention, the non-participant database is built solely from such data. Banks of first deposit are a reliable, current, comprehensive, and broad-based source of checking account activity data, and thus are an ideal candidate for building the non-participant database. Building the non-participant database 20 from transit item files and incoming returns files supplied by banks of first deposit provide significant advantages over conventional approaches to building check acceptance/verification databases, such as positive databases, negative databases and velocity/risk databases. For example, banks of first deposit receive checks from all types of checking accounts (e.g., individual household accounts, commercial/business accounts, institutional accounts), and thus capture data from significantly more accounts and for significantly more types of payments than services that capture only merchant-based checking activity. The non-participant database 20 is updated on a nightly basis as checks are deposited and as checks are returned. The data is therefore very current and accurate. Furthermore, incoming returns are received by the non-participant database 20 before the merchant receives them, since returns are sent first to the depository bank and then to the merchant. Thus, databases that are built from merchant-reported returns will not be as current as the returns logged into the non-participant database 20.

One useful application of the present invention is to allow entities that accept checks to make check hold decisions that are more accurately tailored to the likely risk of a check being returned. The Federal Reserve Board specifies the rules for check holds in Regulation CC, Availability of Funds and Collection of Checks.

Based on the government regulations for hold policies, a large percentage of checks fall into one or more categories that permit a hold greater than one business day, and thus there will be discretion in the hold policy, particularly for deposits eligible for exception holds. In fact, the very existence of a statistically created database that predicts the likelihood of a particular check being returned allows entities that receive checks for payment or clearing to legitimately classify a check as being eligible for exception holds, and thus a longer hold period.

In an alternative embodiment of the present invention, the participant database 10 and non-participant database 20 are used in the following manner to prevent and reduce losses by payment processors, such as credit card companies:

1. A credit card payment is made by check.

2. The check is submitted to the credit card company for payment.

3. The payment processor uses a service such as EWS's PRIME CHEK® to verify the status of the account if it is in the participant database 10, or the likelihood of a return if it is in the non-participant database 20. Depending upon the status or risk of the account, the credit card company makes a decision to place an extended hold on the line of credit until the check actually clears. This protects the credit card company from opening the line of credit to buy before the check clears, thereby preventing customers from implementing “bust out” schemes. The non-participant database 20 significantly expands the number of accounts that can be checked in this manner.

### 2. Detailed Description

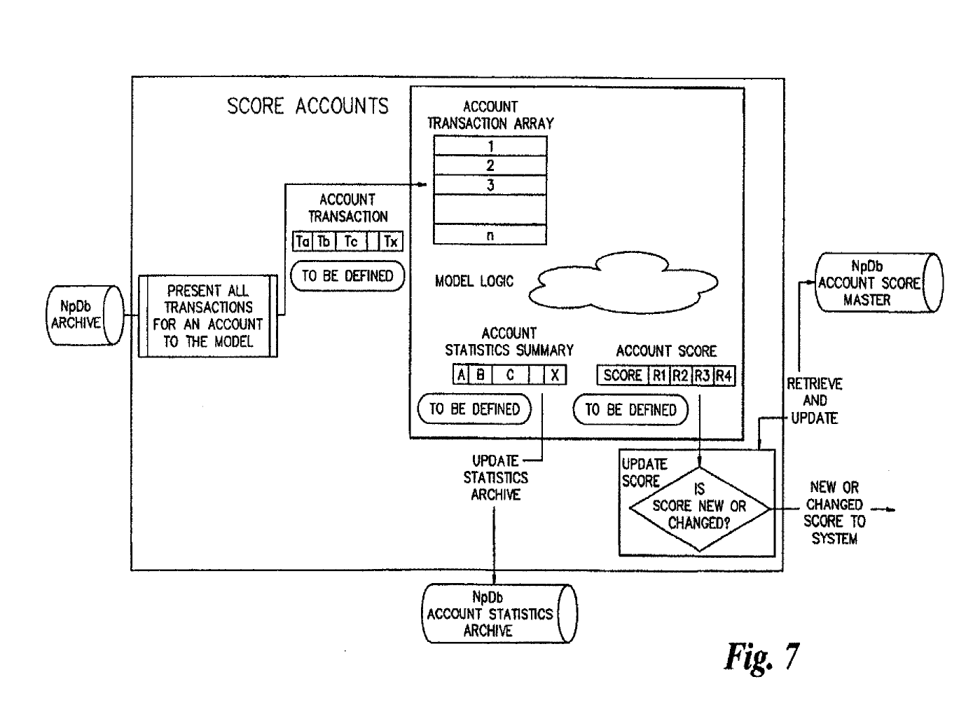

FIG. 7 shows a block diagram of one suitable scoring model process for use in one preferred embodiment of the present invention. The scoring model has a plurality of weighting factors. The actual weighting factors may differ based on fine-tuning and honing of the scoring model, and will change over time. Scoring models are usually proprietary. However, the process for creating a scoring model is well-known. Data is collected and then statistically reviewed to identify patterns of events which predict an outcome. The predictive characteristics are identified and then built into a model.

In alternative embodiments of the present invention, neural models or rules models may be used instead of statistical models and the scope of the present invention includes such variations.

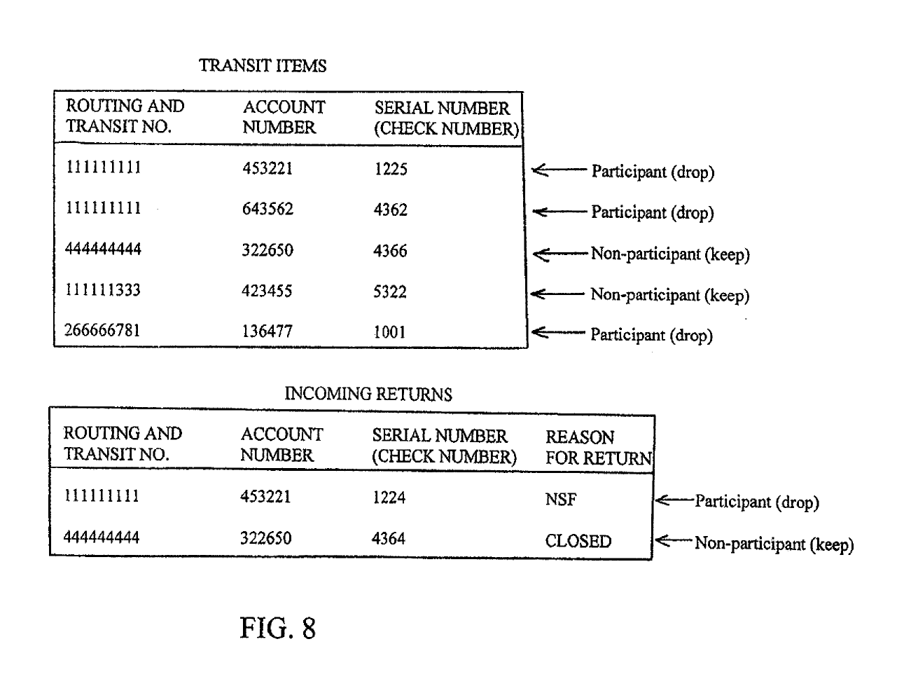

FIGS. 8-12 describe how to populate and maintain the non-participant database 20 (NPDB) by showing how a very small set of sample data is processed.

FIG. 8 shows how data is contributed to the NPDB. The contributor (bank of first deposit) sends its transit item files and incoming returns files. As described above, transit item files contain the MICR line data including the routing and transit number (R&T), account number, tran code or its equivalent if applicable, serial number (check number), dollar amount and date. Incoming returns contain the routing and transit number, account number, tran code or its equivalent if applicable, serial number (check number), date and reason(s) for return. For simplicity, FIG. 8 shows only some of these fields.

The routing and transit number of each transit item and incoming return is used to identify participant and non-participant accounts. This non-participant account data is filtered and sent to the NPDB. FIG. 8 shows five entries from a transit item file. Three entries belong to participants and thus are dropped. The remaining two entries are non-participant accounts and thus are kept. FIG. 8 also shows two entries from an incoming returns file. One entry belongs to a participant and thus is dropped. The other entry is a non-participant account and is kept.

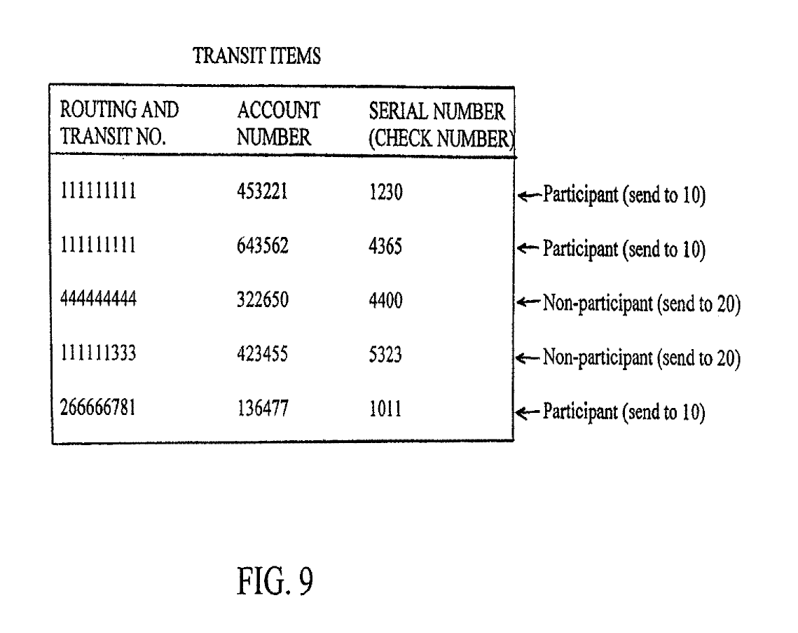

FIG. 9 shows how inquiries are made to the respective participant database and NPDB by a customer of the system (e.g., bank, merchant, payment processor). In this example, the inquiry is a batch mode inquiry on a transit item file made before the checks in the file are sent for clearing, and is being made to determine the hold policy to apply to each of the checks. (The bank has already accepted the checks for deposit.) For simplicity, the accounts in the transit item file are the same as the accounts in the transit item file shown in FIG. 8. The transit item file in FIG. 9 was created shortly after the transit item file in FIG. 8, and thus the check numbers are higher in the FIG. 9 file.

Referring to FIG. 9, the routing and transit number of each transit item is used to identify participant and non-participant accounts. The participant transit items are sent to the participant database 10 for matching against accounts and creation of a first hit report file. The hold policy of each check is then decided based on the checking account status and item level data stored therein. Each bank may have its own rules regarding how checking account status and item level data are used to set the hold policy or any other check risk decision. The nonparticipant transit items are sent to the non-participant database 20 for matching against accounts and creation of a second hit report file. The hold policy of each check is then decided based on the likelihood of clearing score, if one exists. Again, each bank may have its own rules regarding how a risk score is used to set the hold policy or any other check risk decision.

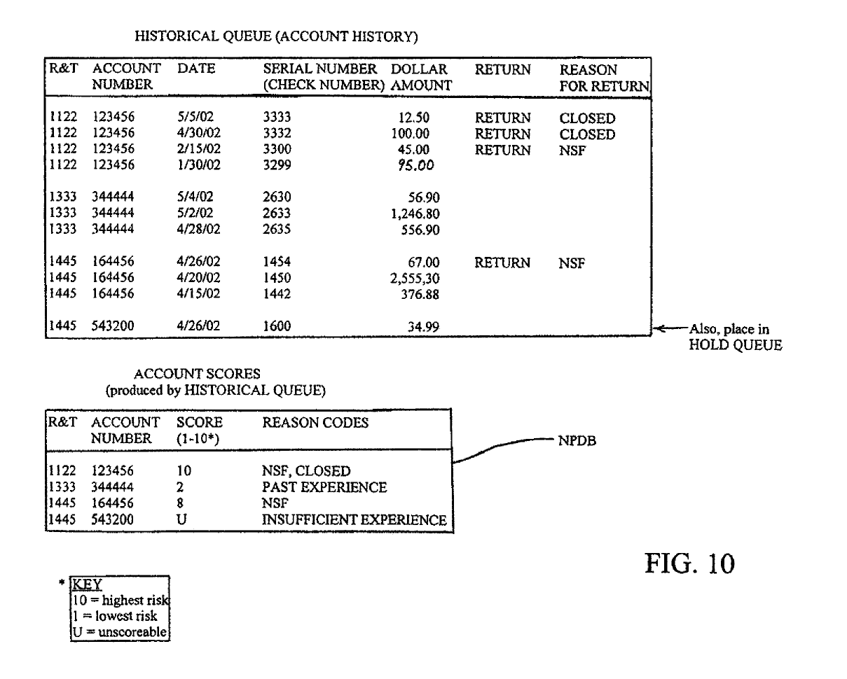

FIG. 10 shows non-participant checking account activity data stored in the historical queue 24 and the actual data stored in the NPDB. The historical queue 24 stores all transaction history data. As new data is contributed, the historical queue 24 is updated. The data in the historical queue is periodically fed to the statistical model which scores the accounts based on the historical transactions. Each account receives a score which is placed in the NPDB, as well as one or more reason codes that relate to the determination of the score. Good scores and bad scores may have reason codes.

FIG. 10 shows transaction data for four checking accounts. In this example, three or more transactions were deemed to be sufficient to make a statistically significant determination of the likelihood that a check from a specific account will be returned. The first account has four transactions, and the last three transactions were returned. This account receives the highest score (highest risk of a subsequent transaction not clearing). The second account has three transactions, all of which cleared. This account received a low score. The third account also has three transactions, but the most recent transaction was a return for insufficient funds. Accordingly, this account received a relatively high score. The fourth account has only one transaction and thus no score was developed for this account. The transaction data for the fourth account is also placed in the hold queue, and is moved out of the hold queue if, or when, a sufficient amount of transaction data becomes available to score the account.

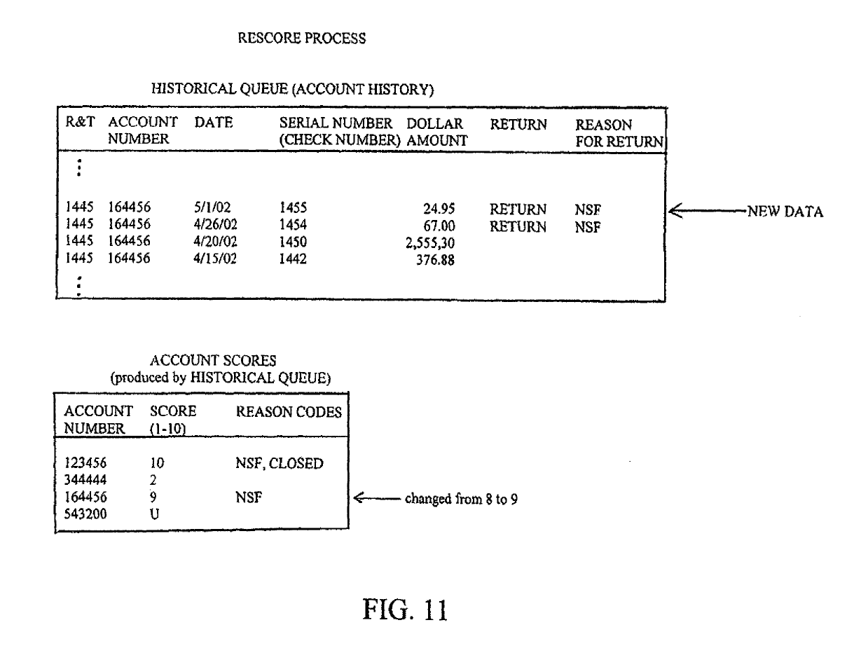

FIG. 11 shows the rescoring process for one account. As new transaction data becomes available for an account, it is added to the historical queue 24 and the account is rescored. The new score replaces the old score. Once the account is rescored, the account is updated on a nightly basis by the system. In FIG. 11, one new transactions appeared for account number 164456 in the latest daily update. The new transaction is another return for insufficient funds. Accordingly, the score for this account is increased from 8 to 9.

In another embodiment of the present invention, the non-participant database management entity 14 receives the transit item files and incoming returns files from a single entity which receives such files from some or all of the banks of first deposit. The single entity may be a check processor or a check clearing entity, such as a clearinghouse or the Federal Reserve. The Federal Reserve receives the most comprehensive flow of data, whereas an individual check processor may receive data from only a small number of banks of first deposit.

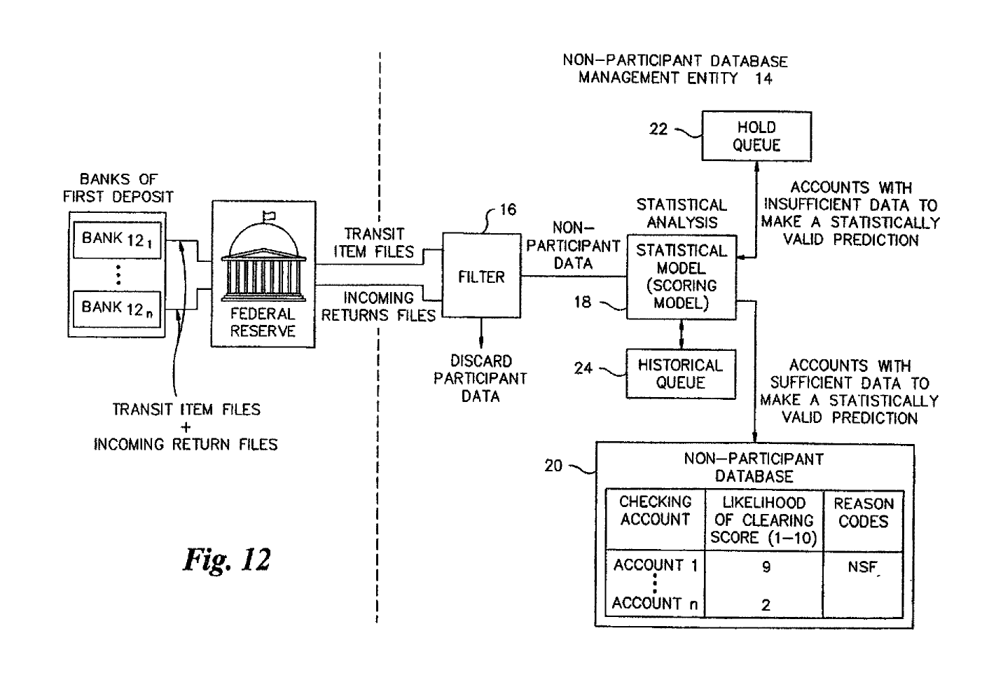

FIG. 12 shows a process wherein the non-participant database management entity 14 receives the transit item files and incoming returns files from the Federal Reserve which receives such files from a plurality of banks of first deposit.

As noted earlier, the contribution of data to the nonparticipant database 20 is received at the non-participant database entity 14 (e.g., FIGS. 4 and 12) from a plurality of different banks. Thus the receipt of transit item files and incoming return files will typically be received in a plurality of different formats, depending on which bank is providing the data. For system efficiency, the various received data files are reformatted by a system at the entity 14 in order to be processed and for scoring and storing at the NPD 20.

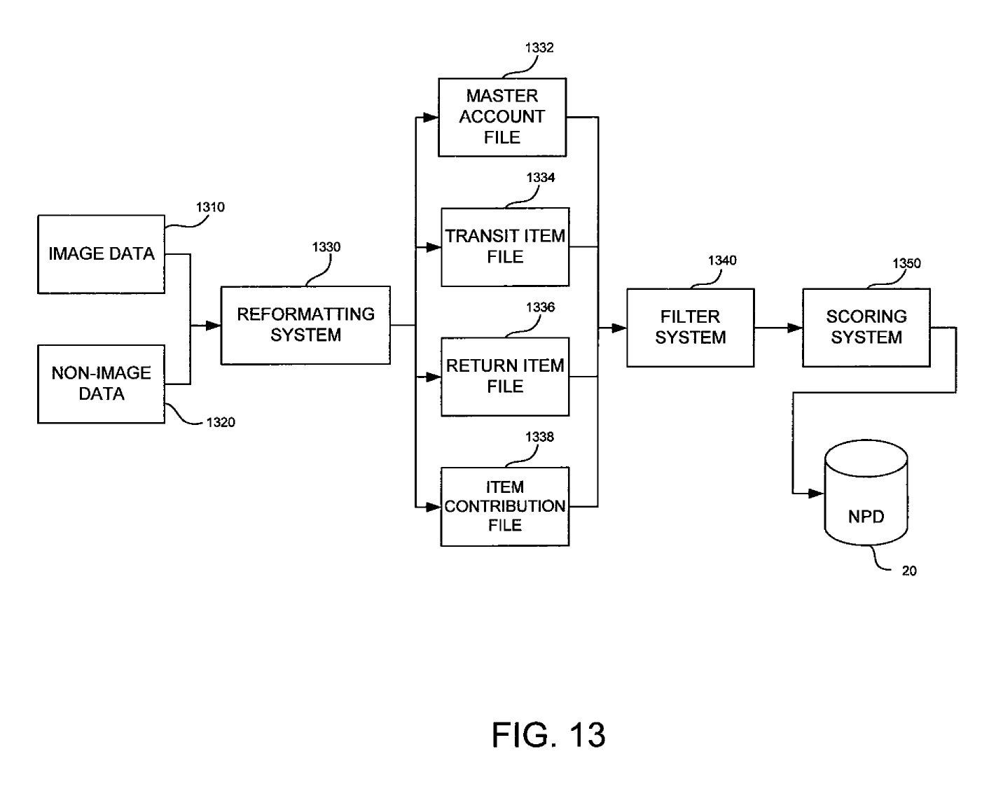

This is illustrated in FIG. 13, wherein the received files can be image data files 1310 (e.g., an image file of the check that is the subject of the transit item or incoming return) and non-image data files 1320 (a data file for a transit item or incoming return that has had the relevant data taken from the check, either manually or electronically, such as by optical code recognition). The image data files 1310 will typically be sent as files from standard banking image systems, e.g., formatted in accordance with industry standards such as an X9 file (see https://www.frbservices.org/assets/financial-services/check/setup/frb-x937-standards-reference.pdf). The data files 1320 have relevant transaction data that is pulled from checks that are the subject of the transit item or incoming return, but the formatting of that data may be variable depending on the bank that is sending it

As seen in FIG. 13, a reformatting system 1330 is maintained at the entity receiving the files, and reformats the incoming transit item and incoming returns into four different file types 1332, 1334, 1336 and 1338. The master account file (MAF) 1332 has data pertaining to the account that is involved with each transit item and incoming return, the transit item file (TIF) 1334 has data relevant only to transit items, the return item file 1336 has data relevant only to return items, and the item contribution file (ICF) 1338 has data relevant to both transit items and return items. Separating the data and reformatting it as shown permits the various data files to be stored and processed in a way most useful to scoring. For example, a score may be tied to a particular account using account characteristics represented at the master account file 1332. Transit items may be processed for scoring using data from each transit item file 1334. Return items are processed for scoring using data from each return item file 1336. In some scoring, data beyond that strictly in the transit item files and return item files may be useful, and the item contribution files 1338 that collect data from all the files received from the banks are accessed for such purpose. When needed to be tied together (e.g., specific account information from an MAF file needs to be pulled in order to consider a risk or associated with a transit item), file IDs resident at each the different file types may be used to locate the relevant file record.

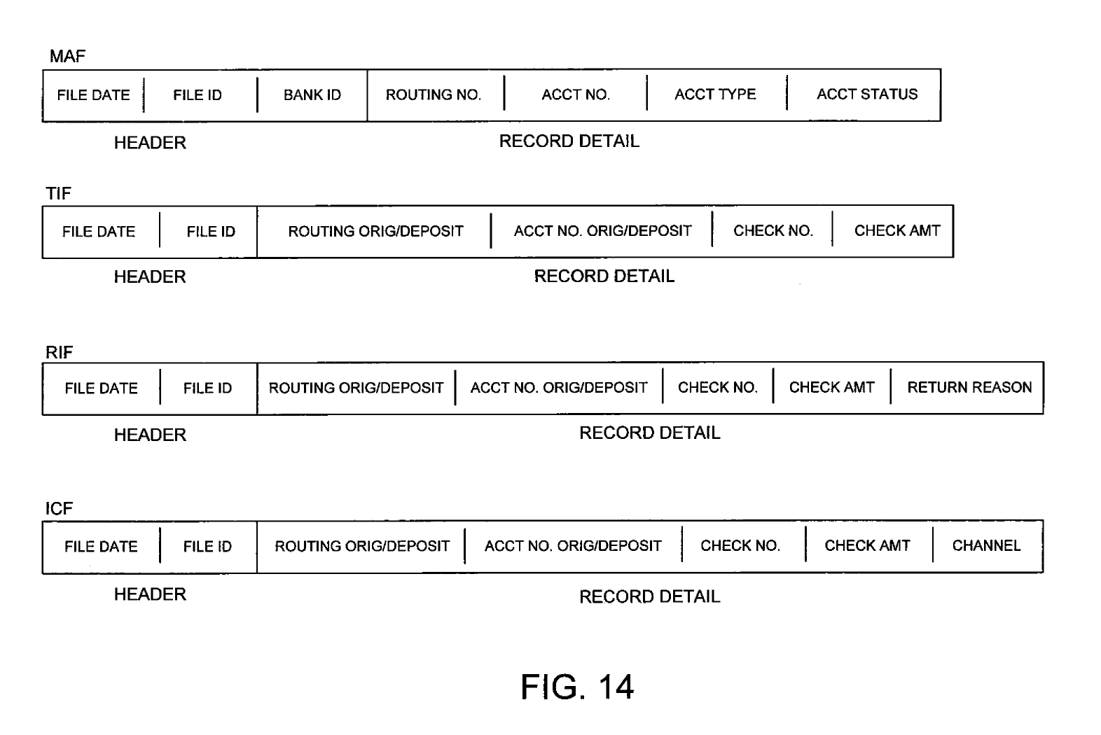

FIG. 14 illustrates the four different file types MAF, TIF, RIF and ICF. For ease of description, the most relevant data fields in the header and record detail for each file type is shown (e.g., control bits in the header are omitted). Thus, the master account (MAF) file 1332 includes fields having a file date, a file ID, and a bank ID in the header, and having a bank routing number, account number, account type an account status associated with a specific account in the record detail. The transit item (TIF) file 1334 includes fields having a file date and file ID in the header, and a routing number for both the originating account and the account to which the item is deposited, an account number for both the originating account and the account into which the item is deposited, a check number, and a check amount in the record detail. The return item (RIF) file 1336 includes fields having a file date and file ID in the header, and a routing number for both the originating account and the account to which the item is deposited, an account number for both the originating account and the account into which the item is deposited, a check number, a check amount, and a return reason (code) in the record detail fields. Thus when accessing the various files, the scoring process will pull the various file types according to what is the specifically needed in that part of the scoring process.

As illustrated in FIG. 13, a filter system 1340 filters out participant files for the NPD 20, and a scoring system 1350 scores the various accounts and also stores those scores in the NPD 20 (see, e.g., FIGS. 4 and 12). The filter system 1340 may use the MAF files 1332 to determine which transit item and incoming returns should be filtered out based on bank IDs associated with participant banks. Further, in some embodiments, scoring for participant banks could also use transit item and incoming returns for scoring participant accounts using data beyond, e.g., account status, etc. In such cases, the participant data filtered out filter system 1342 could be sent to the participant database 10.

As discussed above, for simplicity, both the prior art descriptions and the present invention collectively refer to financial instruments such as debit cards, electronic checks (echecks), and Automated Clearing House (ACH) debit system transactions as “checks.” The scope of the present invention includes these other forms of financial transactions which are ultimately tied into the checking account of a payor institution, and thus are functionally equivalent to paper checks.

Thus, in some embodiments, ACH transactions (such as those processed over existing ACH networks) may be included in checking account activity (e.g., data stored or processed for storage in non-participant database 20, hold queue 22, and historical queue 24) in order to make check risk decisions. When combined with risk assessments from paper check account activity (as earlier described in conjunction with FIGS. 4-12), the inclusion of ACH transactions provide even greater accuracy in assessing the risk of a check being returned.

Examples of ACH transactions include direct deposit payroll payments (credits) and consumer payments (debits) for insurance premiums, mortgage loans, monthly utility payments and other kinds of bills. More recently, ACH transactions have been used at retail locations, where paper checks from customers may be converted by a retailer into electronic ACH debit transactions against checking accounts.

Rules and regulations governing the overall ACH network are established by NACHA (formerly the National Automated Clearing House Association) and the Federal Reserve, and at present most ACH transactions in the United States are processed either through the Federal Reserve Banks or through a private processor known as Electronic Payments Network (EPN).

The following Table 1 shows standard entry codes (SEC codes) for ACH transactions and illustrates various types of ACH transactions that may be processed over the ACH network and that would give rise to ACH transaction data used in order to populate non-participant database 20.

TABLE I
ACH Standard Entry Codes

| Code | Full Title | Description |
|---|---|---|
| ARC | Accounts | Converted checks received via the US |
| | Receivable | mail or at a drop box location |
| | Check | |
| BOC | Back Office | Converted checks received by merchant at |
| | Conversion | the point-of-purchase or at manned bill |
| | | payment locations, and processed during |
| | | back office operations |
| CCD | Cash | Transfer of funds between business accounts |
| | Concentration | or to consolidate funds from several accounts |
| | or Disbursement | of the same business |
| CIE | Customer | Credit entry initiated by an individual |
| | Initiated | (usually through a bill payment service) used |
| | Entry | to pay some sort of obligation |
| CTX | Corporate Trade | Payment or collection of obligations between |
| | Exchange | separate businesses |
| DNE | Death | Notice initiated by an agency of the Federal |
| | Notification | government to advise an RDFI of the death |
| | Entry | of an individual (Includes addenda record |
| | | with details) |
| ENR | Automated | Entry submitted by Financial Institution to |
| | Enrollment | enroll member in direct deposit of Federal |
| | Entry | government benefit payment |
| IAT | International ACH | Transaction involving a financial agency's |
| | Transaction | office that is not located in the territorial |
| | | jurisdiction of the United States |
| POP | Point-of-Purchase | Converted checks received by merchant at |
| | Entry | the point-of-sale |
| POS | Point-of-Sale | Entry initiated by individual at a merchant |
| | Entry | location using a merchant-issued |
| | | card for payment of goods or services |
| PPD | Prearranged | Recurring entry for direct deposit of payroll, |
| | Payment | pension, etc., or for direct payment of |
| | and Deposit Entry | recurring bills such as utilities, loans, |
| | | insurance, etc. |
| RCK | Represented Check | Merchant collection of checks that had been |
| | Entry | returned as NSF or Uncollected Funds |
| TEL | Telephone | Entry submitted pursuant to an oral |
| | Authorized | authorization obtained solely via the |
| | Entry | telephone |
| WEB | Internet | Entry submitted pursuant to an authorization |
| | Authorized | obtained solely via the Internet |
| | Entry | |
| XCK | Destroyed Check | Replacement entry for check that is lost or |
| | Entry | destroyed while within the check clearing |
| | | system |

SEC codes are typically included in any entry of an ACH transaction or ACH return message sent between an originator (the person/entity initiating an ACH debit or credit transaction) and a receiver (the person/entity whose account is receiving the debit or credit).

Some advantages of using ACH transactions in assessing check risk are that the data generated is highly current (ACH transactions are often processed immediately, and some returns may be received at the bank of the originator the next business day), and that data included in ACH transaction and return messages usually provide much more detail than paper check transit item and incoming return files. As one example, ACH entries have standardized data fields with the name of the originator (e.g., the name of the payee in a debit transactions) and, in the case of returns, with detailed “reason for return” codes.

This will be better understood with reference to FIGS. 15 and 16. FIG. 15 illustrates ACH transaction and ACH return files/messages that are received by a participant bank (the originator's bank, which can be thought of as the bank of first deposit) and that are contributed to non-participant database 20. Transit item and incoming return files resulting from the processing of paper checks (such as those earlier described, e.g., in conjunction with FIG. 8) are not illustrated in FIG. 15, but it should be appreciated that such data could be used in addition to the ACH transaction data of FIG. 13 in making risk assessments. The ACH transaction data in FIG. 15 includes routing and transit number, account number, trace number (for uniquely identifying a transaction), effective date, amount and originator ID/Name (e.g., the entity ultimately receiving payment for a debit transaction). The ACH return data likewise includes routing and transit number, account number, trace number, effective date, amount and originator ID/Name, and further includes one of numerous possible return codes (designating the reason for an ACH transaction failing or being returned by the receiver's bank). ACH transaction and return messages and files transmitted over the existing ACH network include other data fields, but those fields are omitted in FIG. 15 for ease of description.

To illustrate the information that may be derived from the reason codes in an ACH return (in comparison to an incoming return for a paper check), the following Table II shows typical reason for return codes that can be included in an ACH return message.

TABLE II
ACH Return Codes

| Code | Description | Comments |
|---|---|---|
| R01 | Insufficient funds | Available balance is not sufficient to |
| | | cover the amount of the debit entry |
| R02 | Bank account closed | Previously active amount has been |
| | | closed by the customer of RDFI |
| R03 | No bank account/unable | Account number does not correspond |
| | to locate account | to the individual identified in the |
| | | entry, or the account number |
| | | designated is not an open account |
| R04 | Invalid bank account | Account number structure is not valid |
| | number | |
| R06 | Returned per ODFI | ODFI requested the RDFI to return the |
| | request | entry |
| R07 | Authorization revoked | Receiver has revoked authorization |
| | by customer | |
| R08 | Payment stopped | Receiver of a recurring debit has |
| | | stopped payment of an entry |
| R09 | Uncollected funds | Collected funds are not sufficient for |
| | | payment of the debit entry |
| R10 | Customer advises | Receiver has advised RDFI that |
| | not authorized | originator is not authorized to debit his |
| | | bank account |
| R11 | Check truncation entry | To be used when returning a check |
| | return | truncation entry |
| R12 | Branch sold to another | RDFI unable to post entry destined for |
| | RDFI | a bank account maintained at a branch |
| | | sold to another financial institution |
| R13 | RDFI not qualified to | Financial institution does not receive |
| | participate | commercial ACH entries |
| R14 | Representative payee | The representative payee authorized to |
| | deceased or unable | accept entries on behalf of a |
| | to continue in that | beneficiary is either deceased or |
| | capacity | unable to continue in that capacity |
| R15 | Beneficiary or bank | Beneficiary deceased (other than |
| | account holder | representative payee) - (1) the |
| | | beneficiary entitled to payments is |
| | | deceased or (2) the bank account |
| | | holder other than a representative |
| | | payee is deceased |
| R16 | Bank account frozen | Funds in bank account are unavailable |
| | | due to action by RDFI or legal order |
| R17 | File record edit criteria | Fields rejected by RDFI processing |
| | | (identified in return addenda) |
| R18 | Improper effective | Entries have been presented prior to |
| | entry date | the first available processing window |
| | | for the effective date. |
| R19 | Amount field error | Improper formatting of the amount |
| | | field |
| R20 | Non-payment bank | Entry destined for non-payment bank |
| | account | account |
| R21 | Invalid company ID | The company ID information not valid |
| | number | (normally CIE entries) |
| R22 | Invalid individual ID | Individual ID used by receiver is |
| | number | incorrect (CIE entries) |
| R23 | Credit entry refused | Receiver returned entry because |
| | by receiver | minimum or exact amount not |
| | | remitted, bank account is subject to |
| | | litigation, or payment represents an |
| | | overpayment, originator is not known |
| | | to receiver or receiver has not |
| | | authorized this credit entry to this bank |
| | | account |
| R24 | Duplicate entry | RDFI has received a duplicate entry |
| R25 | Addenda error | Improper formatting of the addenda |
| | | record information |
| R26 | Mandatory field error | Improper information in one of the |
| | | mandatory fields |
| R27 | Trace number error | Original entry trace number is not |
| | | valid for return entry; or addenda trace |
| | | numbers do not correspond with entry |
| | | detail record |
| R28 | Transit routing number | Check digit for the transit routing |
| | check digit error | number is incorrect |
| R29 | Corporate customer | RDFI has been notified by corporate |
| | advises not authorized | receiver that debit entry of originator |
| | | is not authorized |
| R30 | RDFI not participant in | Financial institution not participating |
| | check truncation program | in automated check safekeeping |
| | | application |
| R31 | Permissible return entry | RDFI has been notified by the ODFI |
| | (CCD and CTX only) | that it agrees to accept a CCD or CTX |
| | | return entry |
| R32 | RDFI non-settlement | RDFI is not able to settle the entry |

In conjunction with Tables I and II, and is well understood by those skilled in the art, an “ODFI” is the Originating Depository Financial Institution (e.g., the bank of the originator, i.e., the party who initiates an ACH transaction), and an “RDFI” is the Receiving Depository Financial Institution (e.g., the bank of the receiver or the party whose account receives an ACH transaction).

Returning to FIG. 15, both ACH transactions and ACH returns are used to score checking account activity. For example, the name of the originator as a payee (the entity that initiates the ACH transaction for a debit against the receiver's checking account), will often reflect the kinds of payments being made by the checking account customer or account holder, and can be used to assess that customer's credit worthiness. For example, ACH payments to mortgage companies and insurance companies that are not returned will usually indicate the account holder is a person with assets, and having good credit worthiness. Another example of more complete information provided in ACH transactions are the return reason codes in the ACH returns, which contain extensive information that will enable a check risk assessing service to disregard some returns when the reasons for a return do not accurately reflect the risk of accepting checks. As one example, a return sent back to the originator because it has been submitted twice, reason code R24 (Table II) will have very little, if any, relevance to the credit worthiness of the account holder, absent other negative information.

Further, the statistical models and other scoring models used for ACH transactions can be similar to those used for paper checks. As examples only, a risk assessment service may use a scoring model process seen in FIG. 7, and then use some of the exemplary risk assessment factors in the following Table III.

TABLE III

| | |
|---|---|
| Ratio of ACH returns to successful ACH | High Ratio - increased risk |
| transactions over either established time | Low Ration - decreased risk |
| period (e.g., 90 days) or established | |
| number of ACH transactions (e.g., last | |
| 25 transactions) | |
| Changing Rate of ACH transactions | Higher Rate - decreased risk |
| (assuming no change in rate of returned) | Lower Rate - increased risk |
| Ratio of total dollars in ACH returns to | High ratio - increased risk |
| total dollars in all ACH transactions over | Low ratio - decreased risk |
| established time period (e.g., 90 days) | |

As mentioned earlier, many scoring models and processes are well known in conjunction with paper check transactions (transit items and return files). Such models could be applied to both ACH transactions and paper check transactions. Further, the scores resulting from ACH transactions and from paper check transactions can be combined, along with other information about the check presenter (as described earlier), to arrive at an overall risk assessment or score for a checking account.

FIG. 16 illustrates ACH transactions stored in historical queue 24 and exemplary risk data stored in the non-participant database 20 (generally corresponding to the data related to paper checks described earlier in conjunction with FIG. 10). While FIGS. 15 and 16 show the data only for ACH transactions (and not including the separate paper check activity seen earlier in FIGS. 8 and 10), it should be appreciated that the ACH transaction data and paper check activity data could be stored together (and scored together) in non-participant database 20.

In addition, while the forgoing description assumes that ACH transactions will be used to score only non-participant accounts (as reflected by the score in non-participant database 20), scoring of ACH transactions may also be useful in augmenting account status and item level data used in participant database 10. For example, while a participant account status may be positive as indicated in participant database 10 (“open” or “present” with a positive balance) and have no negative item level data, the use of more detailed (and more quickly processed) ACH transaction and ACH return data (similar to that illustrated in FIGS. 13 and 14 for non-participant database 20) could likewise be used to provide more detailed and current information to participant database 10 for purposes of assessing check risk associated with participant accounts.

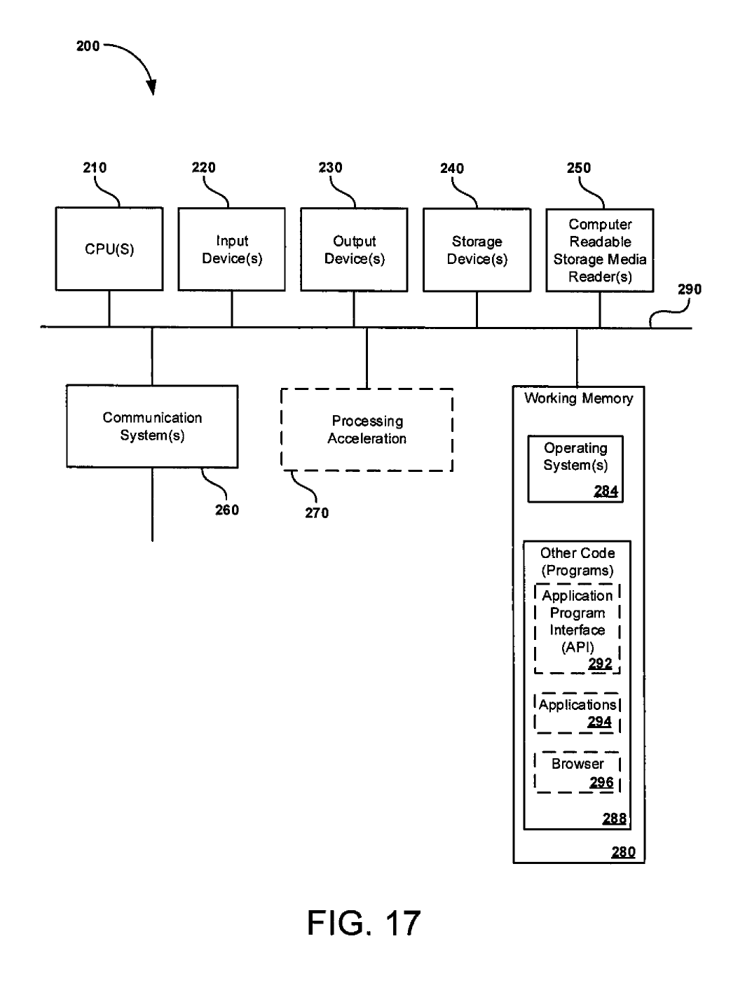

FIG. 17 is a block diagram illustrating an exemplary computer system upon which embodiments of the present invention may be implemented. This example illustrates a computer system 100 such as may be used, in whole, in part, or with various modifications, to provide the functions of the computers that process checking account activity data at the check risk service, receive and use account identification data, score accounts using the scoring model illustrated in FIG. 7, manage and perform the function of the databases 10 and 20, as well as other components and functions of the invention described herein.

The computer system 100 is shown comprising hardware elements that can be electrically coupled or otherwise in communication via a bus 105. The hardware elements can include one or more processors 110, including, without limitation, one or more general-purpose processors and/or one or more special-purpose processors (such as digital signal processing chips, graphics acceleration chips, and/or the like); one or more input devices 115, which can include, without limitation, a mouse, a keyboard and/or the like; and one or more output devices 120, which can include, without limitation, a display device, a printer and/or the like.

The computer system 100 may further include one or more storage devices 125, which can comprise, without limitation, local and/or network accessible storage or memory systems having computer or machine readable media. Common forms of physical and/or tangible computer readable media include, as examples, a floppy disk, a flexible disk, hard disk, magnetic tape, or any other magnetic medium, an optical medium (such as CD-ROM), a random access memory (RAM), a read only memory (ROM) which can be programmable or flash-updateable or the like, and any other memory chip, cartridge, or medium from which a computer can read data, instructions and/or code. In many embodiments, the computer system 100 will further comprise a working memory 130, which could include (but is not limited to) a RAM or ROM device, as described above.

The computer system 100 also may further include a communications subsystem 135, such as (without limitation) a modem, a network card (wireless or wired), an infra-red communication device, or a wireless communication device and/or chipset, such as a Bluetooth® device, an 802.11 device, a WiFi device, a near field communications (NFC) device, cellular communication facilities, etc. The communications subsystem 135 may permit data to be exchanged with a network, and/or any other devices described herein. Transmission media used by communications subsystem 135 (and the bus 105) may include copper wire, coaxial cables and fiber optics. Hence, transmission media can also take the form of waves (including, without limitation radio, acoustic and/or light waves, such as those generated during radio-wave and infra-red data communications).

The computer system 100 can also comprise software elements, illustrated within the working memory 130, including an operating system 140 and/or other code, such as one or more application programs 145, which may be designed to implement, as an example, the processes involved in FIGS. 4-14, and thus provide specially designed and programmed systems (rather than well-understood, routine and conventional activities and systems in the prior art) for carrying out the unique elements of those processes and novel features described herein.

As an example, one or more methods discussed earlier might be implemented as code and/or instructions executable by a computer (and/or a processor within a computer). In some cases, a set of these instructions and/or code might be stored on a computer readable storage medium that is part of the system 100, such as the storage device(s) 125. In other embodiments, the storage medium might be separate from a computer system (e.g., a removable medium, such as a compact disc, etc.), and/or provided in an installation package with the instructions/code stored thereon. These instructions might take the form of code which is executable by the computer system 100 and/or might take the form of source and/or installable code, which is compiled and/or installed on the computer system 100 (e.g., using any of a variety of generally available compilers, installation programs, compression/decompression utilities, etc.). The communications subsystem 135 (and/or components thereof) generally will receive the signals (and/or the data, instructions, etc., carried by the signals), and the bus 105 then might carry those signals to the working memory 130, from which the processor(s) 105 retrieves and executes the instructions. The instructions received by the working memory 130 may optionally be stored on storage device 125 either before or after execution by the processor(s) 110.

Moreover, while the various flows and processes described herein (e.g., those involved in FIGS. 4-16) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A multi-database system structure for facilitating account verification through a member service, comprising:
a first database system maintained by the member service;
a second database system maintained by the member service;
a computer management system at the member service for managing data at the first and second database systems and providing access to the data at the first and second database systems, the computer management system programmed for:
receiving and storing, at the first database system, status data relating to accounts maintained by a plurality of member institutions that belong to the member service, the status data received from the member institutions, wherein the member institutions are financial institutions that belong to the member service for assessing risk that a transaction will not clear;
receiving and storing, at the second database system, account activity data relating to accounts of a plurality of non-member institutions that do not belong to the member service, the account activity data based on files from banks of first deposit;
filtering the activity data received at the second database system to remove activity data relating to accounts maintained by member institutions, and thereby storing in the second database system only data relating to accounts of non-member institutions that do not belong to the member service;
populating the second database system with risk data reflecting the likelihood that a transaction conducted against a specific account will not clear, as determined by a risk scoring model and based on the account activity data stored at the first database system;
receiving, at the computer management system, account data relating to an account against which a transaction is conducted;
using the account data, at the computer management system, to determine if the transaction is conducted against one of the accounts of member institutions that belong to the member service and to determine if the transaction is conducted against one of the accounts of non-member institutions that do not belong to the member service;
accessing the first database system to retrieve data for accounts of member institutions that belong to the member service; and
accessing the second database system to retrieve data for accounts of non-member institutions that do not belong to the member service;
wherein an inquiring institution makes a risk decision for accounts of member institutions based on status data accessed from the first database system and makes a risk decision for accounts of non-member institutions based on risk data accessed from the separate, second database system.

2. The system of claim 1, wherein account activity data stored at the second database system is contributed by member institutions that are banks of first deposit and relating to accounts not maintained by the member institutions.

3. The system of claim 1, wherein the accounts are checking accounts.

4. The system of claim 3, wherein the account activity data received and stored at the second database system comprises transit item files and corresponding incoming return item files from the banks of first deposit.

5. The system of claim 3, wherein the status data received and stored at the first database system is taken from a group comprising one or more of account present (balance greater than zero) status, new account status, closed account status, and non-sufficient funds (NSF) status.

6. The system of claim 3, wherein the first database system further receives and stores item level data, wherein the item level data is taken from a group comprising one or more of stop payments and early outgoing return notices.

7. The method of claim 3, wherein the activity data relates to a paper check drawn against the accounts.

8. The method of claim 1, wherein the account activity data relates to an electronic transaction against the accounts.

9. The method of claim 8, wherein the electronic transaction is an automated clearinghouse (ACH) transaction.

10. The method of claim 1 wherein the member service operates the computer system, the first database system and the second database system.

11. The method of claim 10, wherein member institutions subscribe to the service in order to access the status data stored in the first database system relating to accounts of member institutions, and access risk data in the second database system relating to accounts of non-member institutions.

12. The method of claim 1, wherein the risk decision is a check acceptance decision.

13. The method of claim 1, wherein the risk decision is a check hold policy decision.

14. The method of claim 1, wherein the risk decision is an open to buy decision by a payment processor, pending a check clearing.

15. The method of claim 1, wherein the risk data comprises a score relating to the likelihood of a transaction against an account not clearing, and wherein the method further comprises determining the score by the risk scoring model using the account activity data received at the second database system.

16. In a multi-database system for facilitating a risk decision through a member service, a method for managing data, comprising:
receiving and storing, at a first database system, status data relating to accounts maintained by a plurality of member institutions that belong to the member service, the status data received from the member institutions, wherein the member institutions are financial institutions that belong to the member service for assessing risk that a transaction will not clear;
receiving and storing, at a second database system, account activity data relating to accounts of a plurality of non-member institutions that do not belong to the member service, the account activity data based on files from banks of first deposit;
filtering the activity data received at the second database system to remove activity data relating to accounts maintained by member institutions, and thereby storing in the second database system only data relating to accounts of non-member institutions that do not belong to the member service;
populating the second database system with risk data reflecting the likelihood that a transaction conducted against a specific account will not clear, as determined by a risk scoring model and based on the account activity data stored at the first database system;
receiving, at a computer management system for managing and accessing data at the first a second database systems, account data relating to an account against which a transaction is conducted;
using the account data, at the computer management system, to determine if the transaction is conducted against one of the accounts of member institutions that belong to the member service and to determine if the transaction is conducted against one of the accounts of non-member institutions that do not belong to the member service;
accessing the first database system to retrieve data for accounts of member institutions that belong to the member service; and
accessing the second database system to retrieve data for accounts of non-member institutions that do not belong to the member service;
wherein an inquiring institution makes a risk decision for accounts of member institutions based on status data accessed from the first database system and makes a risk decision for accounts of non-member institutions based on risk data accessed from the separate, second database system.

17. The method of claim 16, wherein account activity data stored at the second database system is contributed by member institutions that are banks of first deposit and relating to accounts not maintained by the member institutions.

18. The system of claim 16, wherein the accounts are checking accounts.

19. The system of claim 18, wherein the account activity data received and stored at the second database system comprises transit item files and corresponding incoming return item files from the banks of first deposit.

20. The system of claim 18, wherein the status data received and stored at the first database system is taken from a group comprising one or more of account present (balance greater than zero) status, new account status, closed account status, and non-sufficient funds (NSF) status.
